(19) United States
(12) Patent Application Publication
(10) Pub. No.: US 2006/0227948 A1
(43) Pub. Date: Oct. 12, 2006

(54) System and method for implementing call controls in a telephony network

(75) Inventors: Larry B. Pearson, San Antonio, TX (US); Jeffrey L. Brandt, Cedar Park, TX (US); James T. Miller, Austin, TX (US); James M. Doherty, Georgetown, TX (US); Stephen M. Mueller, Austin, TX (US)

Correspondence Address: HANLEY, FLIGHT & ZIMMERMAN, LLC, 20 N. WACKER DRIVE, SUITE 4220, CHICAGO, IL, 60606, US

(73) Assignee: SBC Knowledge Ventures, L.P., Reno, NV (US)

(21) Appl. No.: 11/102,484

(22) Filed: Apr. 8, 2005

(51) Int. Cl. H04M 15/00

(52) U.S. Cl. 379/136; 379/112.01; 379/133; 379/140

(57) ABSTRACT

In one embodiment according to the invention, there is disclosed a method for implementing call controls in a telephony network. The method comprises processing a call log of actual calls for an individual end user of the telephony network to identify applicability, for each call of the call log, of each rule of a set of call control rules; and providing a display of a call disposition that would occur for at least one call in the call log, assuming implementation of the set of call control rules. Another embodiment according to the invention comprises providing a call log of calls for an individual end user of the telephony network; and providing a display of a call control rule applied to a call of the call log. The display of the call control rule comprises an identification of one or more criteria that triggered application of the call control rule, and a disposition of the call as a result of the call control rule.

### BACKGROUND OF THE INVENTION

Current telephony networks support complex call controls by end-users. Call controls are rules that are applied to inbound and outbound calls to and from a subscriber's phone. The rules tell the underlying telephone network, in an identification portion of the rule, how to identify a call to which the rule applies; and, in a disposition portion of the rule, what to do with the call once it has been identified. Because the list of call control rules is often complex, it can be difficult for a customer to predict the consequences of changing their call control rules.

### SUMMARY OF THE INVENTION

End-users have been unable to assess the impact of changes they make in their call control configuration. In one embodiment according to the invention, there is provided a method for implementing call controls in a telephony network. The method comprises processing a call log of actual calls for an individual end user of the telephony network to identify applicability, for each call of the call log, of each rule of a set of call control rules; and providing a display of a call disposition that would occur for at least one call in the call log, assuming implementation of the set of call control rules.

In further related embodiments, the set of call control rules may include call control rule changes proposed by the end user but not yet implemented. The display of the call disposition may be on the end user's customer premises equipment, or on a graphical user interface. The call log may comprise inbound calls to the end user, or outbound calls from the end user, or both. The telephony network may comprise a Voice over Internet Protocol network, a wireless network, a Time Division Multiplexed network, an Advanced Intelligent network, or any combination thereof. The method may be applied to a call log in a voicemail service, or in a Unified Messaging Service. The method may further comprise providing a user interface element to receive a request from the end user to initiate the processing of the call log based on the set of call control rules. The user interface element may comprise a button. The method may also further comprise receiving, via end user interaction with a user interface element, a request to initiate the processing of the call log based on the set of call control rules. Each call control rule of the set of call control rules may comprise an identification portion and a disposition portion. The calls may comprise facsimile calls. The method may further comprise providing a familiar name of a call control rule; such as providing a display of a familiar name of a particular call control rule that caused the call disposition for the at least one call. The method may further comprise displaying, in real time, the call control rule being applied to the call.

In another embodiment according to the invention, there is provided a further method for implementing call controls in a telephony network. The method comprises providing a call log of calls for an individual end user of the telephony network; and providing a display of a call control rule applied to a call of the call log, the display of the call control rule comprising: an identification of one or more criteria that triggered application of the call control rule, and a disposition of the call as a result of the call control rule.

In another embodiment according to the invention, there is provided a system for implementing call controls in a telephony network. The system comprises a call identification engine for processing a call log of actual calls for an individual end user of the telephony network to identify applicability, for each call of the call log, of each rule of a set of call control rules; and a customer rule change module for providing a display of a call disposition that would occur for at least one call in the call log, assuming implementation of the set of call control rules.

In further, related embodiments, the set of call control rules may include call control rule changes proposed by the end user but not yet implemented. The display may be on the end user's customer premises equipment, or on a graphical user interface. The system may further comprise a user interface element for receiving a request to initiate the processing of the call log based on the set of call control rules. The user interface element may comprise a button, which may be a button on the customer premises equipment.

In another embodiment according to the invention, there is provided a system for implementing call controls in a telephony network. The system comprises a call log module for providing a call log of calls for an individual end user of the telephony network; and a call control module for providing a display of a call control rule applied to a call of the call log, the display of the call control rule comprising: an identification of one or more criteria that triggered application of the call control rule, and a disposition of the call as a result of the call control rule.

The system may further comprise a user interface element for receiving a request to display the call control rule applied to the call of the call log.

In another embodiment according to the invention, there is provided a method for implementing call controls in a telephony network. The method comprises applying a call control rule to an actual call transmitted to the telephony network; and providing a display, in real time, of the call control rule being applied to the actual call, the display of the call control rule comprising: an identification of one or more criteria that triggered application of the call control rule, and a disposition of the call as a result of the call control rule.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a display that allows a customer to see the impact of call control changes on their own call log of actual calls, before that change is activated in the telephone system, according to an embodiment of the invention;

FIG. 2 shows a user interface for allowing a customer to activate the display of FIG. 1, in accordance with an embodiment of the invention;

FIG. 3 is a block diagram of the processing initiated by the telephony network, in order to provide the display of FIG. 1, in accordance with an embodiment of the invention;

FIG. 4 shows a display of a call log that identifies which, if any, call control rule was applied to each call, in accordance with an embodiment of the invention;

FIG. 5 shows a user interface for allowing a customer to interact with the display of FIG. 4, in accordance with an embodiment of the invention;

FIG. 6 is a block diagram of the processing carried out by the telephony network in order to provide the display of FIG. 4, in accordance with an embodiment of the invention; and

FIG. 7 shows a Voice over Internet Protocol network, in which an embodiment according to the invention may be implemented.

### DETAILED DESCRIPTION OF THE INVENTION

Because of the complexities of call control rules, users of telephony networks often cannot easily tell what the impact of changing their call control rules would be on their calls. A list of the identification portions of a set of call control rules for inbound calls, which tell how to identify calls to which each given rule applies, might be as in the following example list:

1. Number is (or is not) in Personal Address Book

2. Number is (or is not) equal to a provided telephone number.

3. Number matches (or does not match) a provided pattern (e.g. 210-886-*).

4. Number is (or is not) UNKNOWN.

5. Number is (or is not) PRIVATE.

6. Number station class is (or is not) a payphone, hotel, or other given station class.

7. Number is (or is not) Inter-LATA.

8. Name is (or is not) a provided caller name.

9. Name matches (or does not match) a provided pattern (e.g. PEARSON*).

10. Time equals (or does not equal) a provided time.

11. Time is (or is not) between a provided start time and a provided stop time.

As an example of the uses of identification portions of rules such as the above, a service emulating a privacy manager may use the “Number is UNKNOWN” rule to identify when a call should be handled by the privacy manager. A service may emulate Anonymous Call Rejection by using the “Number is PRIVATE” rule to identify when to reject a call. A service may emulate Selective Call Forwarding by using a rule whose identification portion is “Number in List {provided number 1, . . . , provided number N}.”

From the number of identification portions in the above list, however, it is clear that call controls can become quite complex. They become more complex when a similar example of a list of the disposition portion of rules for inbound calls, which indicate what to do with a call once it has been identified, is considered:

1. Pass the call through.

2. Pass the call through with a special ring tone.

3. Call Forward to voicemail.

4. Call Forward to a provided system defined announcement.

5. Call Forward to a provided customer defined announcement.

6. Call Forward to a provided number.

7. Interactive call screening (like a privacy manager) with or without PIN or PRIVATE override.

8. Interactive call blocking with or without PIN or PRIVATE override.

9. Find-Me-Follow-Me (also known as Single Number Reach).

10. Makebusy.

11. Make Ring No Answer.

As an example of the uses of disposition portions of rules such as the above, a privacy manager may use “Interactive Call Screening” as a disposition. Anonymous Call Rejection may use an announcement (“Interactive Call Blocking”). Selective Call Forwarding may use “Call Forward to a provided number” as a disposition.

From the number of such identifications and dispositions listed above, it can be seen that the consequences of changing call control rules can be very difficult for a customer to predict. Generally, inbound and outbound call logs are made available to customers, in telephony networks that provide complex call controls, so that customers can see calls made to or from their telephone number. However, existing call logs do not show the customer which call control rules were applied to their calls.

Therefore, in order to improve the customer's interaction with call control rules, a first embodiment according to the invention allows a customer to see the impact of their call control changes on their own call log of actual calls, before that change is activated in the telephone system. A second embodiment provides a call log that identifies which, if any, call control rule was applied to each call, thereby telling the customer specifically what about the call made it trigger the call control rule.

In this way, embodiments according to the invention allow customers to experiment with complex call controls in a controlled environment before making configuration changes to their live active telephone service. Customers are therefore less likely to blame the service for configuration mistakes; and can know that changes to their call controls will not change their service in unpleasant or unanticipated ways.

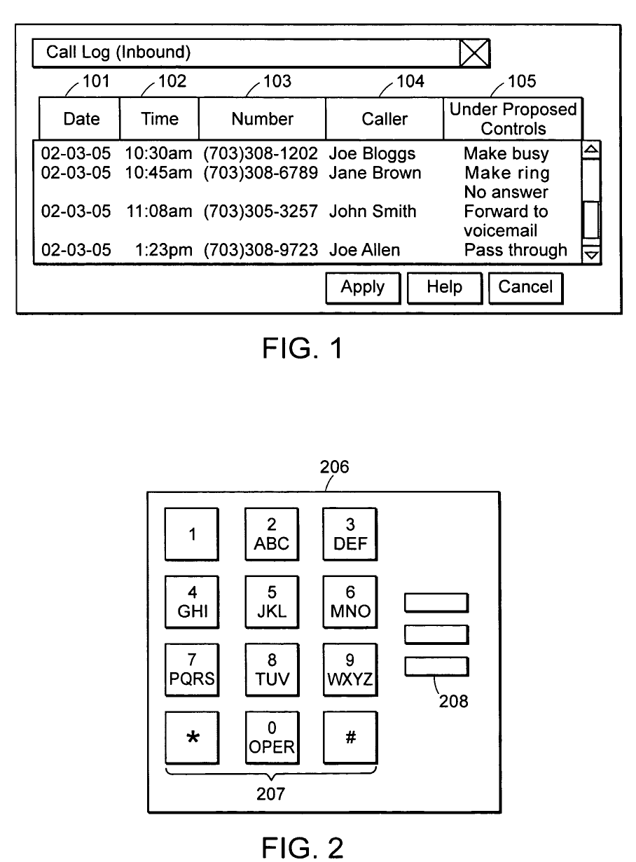

FIG. 1 shows a display 100 that allows a customer to see the impact of call control changes on their own call log of actual calls, before that change is activated in the telephone system, according to a first embodiment of the invention. The display 100 includes details of actual received calls, including the date 101, time 102, calling number 103, and caller name 104, although all of these details need not necessarily be displayed. A similar log may be provided for outbound calls. As can be seen in column 105, the embodiment of FIG. 1 allows the user to see what would be the disposition 105 of each actual call in the call log 100 under a set of call control rules proposed by the user. Furthermore, in addition to, or instead of, the information in column 105, the embodiment of FIG. 1 may display a name of the call control rule that would be applied, using a name that may be more familiar to the user, such as “Anonymous Call Rejection” or “Selective Call Forwarding.”

Before generating the display of FIG. 1, the network may obtain the proposed set of call control rules from the user, in any of a variety of different possible ways. For example, the network may prompt the user to select a proposed call control rule from a list of menu options (such as “Anonymous Call Rejection,” “Selective Call Forwarding,” and so on). Once the user has selected the proposed call control rules, he or she may test the effect of the proposed rules by requesting the network to activate the display of FIG. 1.

FIG. 2 shows a user interface for allowing a customer to activate the display of FIG. 1, in accordance with an embodiment of the invention. The user interface 206 includes a number of conventional buttons on a telephone handset 207, as well as an additional user interface element 208, such as a button, that allows the customer to view the display of FIG. 1. The user interface 206 need not be limited to being a set of buttons on a telephone handset, but may also be implemented in a variety of other ways, including using a keyboard and mouse and/or a web interface featuring a web button, for acting as the user interface element 208.

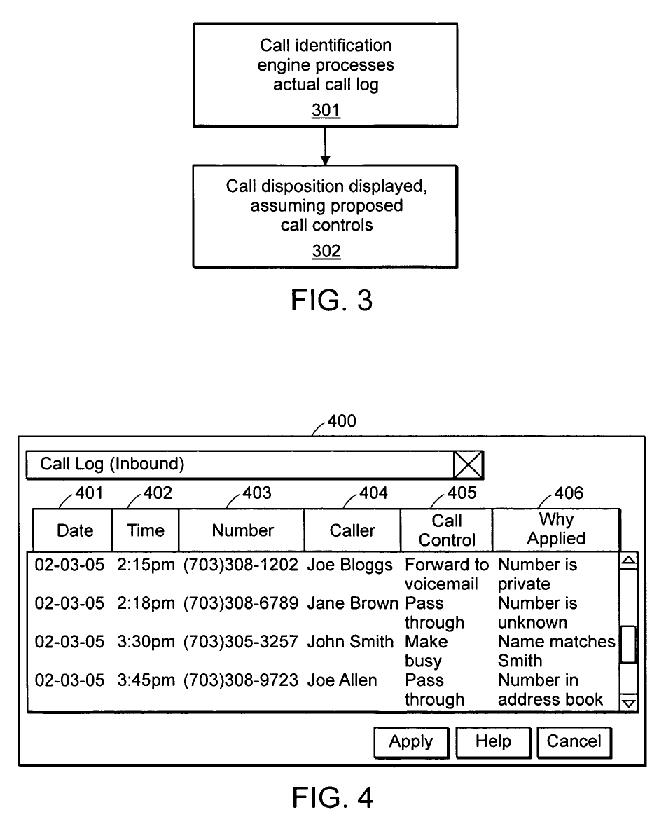

FIG. 3 is a block diagram of the processing initiated by the telephony network in order to provide the display of FIG. 1, in accordance with an embodiment of the invention. First, the customer activates the user interface element 208 of FIG. 2, in order to request provision of the display of FIG. 1. Next, a call identification engine processes 301 the customer's actual call log 101-104 of FIG. 1, using the call control rules that have been proposed by the customer to determine what disposition would have been made for the calls in the call log, assuming the proposed rules had been implemented. Next, the call disposition is displayed 302, as in column 105 of FIG. 1. The display 105 need not necessarily include the disposition of all calls in the user's actual call log; but could instead include only the disposition of calls whose disposition would be changed by implementation of the proposed rules. In such a case, additional processing could be used to compare the results of existing call controls to the proposed call controls. The display of FIG. 1 may optionally include side-by-side columns, one showing call dispositions of the calls under the existing call controls, and the other showing dispositions under the proposed controls (as in column 105).

FIG. 4 shows a display of a call log that identifies which, if any, call control rule was applied to each call, in accordance with a second embodiment of the invention. In addition to the details 401-404 of the received calls (a similar display may be used for outgoing calls), the display of FIG. 4 shows the dispositions 405 that have been applied to the calls in the existing call log 400. As in FIG. 1, not all of the details 401-404 need necessarily be displayed.

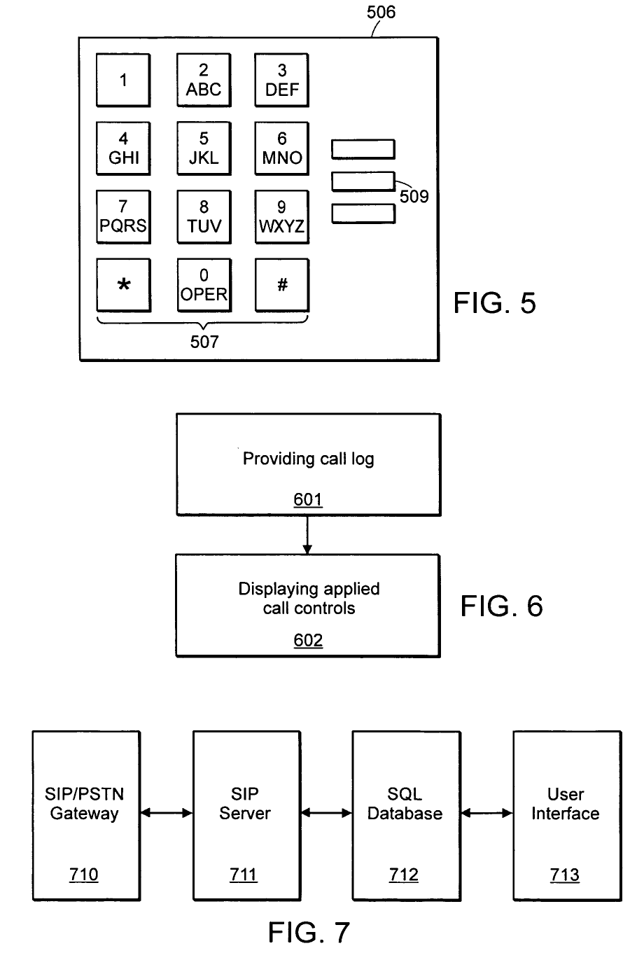

Once the user has viewed the applied call controls 405 of FIG. 4, the user may wish to determine specifically what about each call made it trigger the call control rule. To request this, the user may interact with the user interface 506 of the embodiment of FIG. 5. In addition to the conventional telephone buttons 507, the user interface of FIG. 5 includes user interface element 509. When the user activates user interface element 509, the display of FIG. 4 shows the user what about each call made it trigger the call control rule. This may be done, for example, by displaying an indicator such as in column 406 of the embodiment of FIG. 4, in which a description of the identifier portion of each applied rule is shown. For example, the first call has been forwarded to voicemail as a result of a rule that is activated when the number is private. In addition to, or instead of, the information in columns 405 and 406, an embodiment according to the invention may display a name of the applied call control rule that may be more familiar to a user, such as “Anonymous Call Rejection.” The indications of column 406 need not be displayed in a column as in FIG. 4, but may also be displayed in a variety of different ways, such as in a separate menu or an individual pop-up menu for each call. Also, the user interface 406 may be implemented in a variety of ways, such as a set of buttons on a telephone handset, or via a web interface with web buttons and links, and/or via a keyboard and mouse. It should also be appreciated that the displays of FIGS. 1 and 4 may be combined with each other, and the user interfaces of FIGS. 2 and 5 may be combined with each other; or, in some graphical user interfaces, all four may be combined in a single graphical user interface. User interface elements 208 and 509 may be provided as part of a separate call control configuration interface, which need not necessarily be part of a handset. The displays of FIGS. 1 and 4 may be presented on the user's customer premises equipment, or on a graphical user interface, which may be accessed remotely; or may be provided in audio form, including by remote access to a messaging service.

FIG. 6 is a block diagram of the processing carried out by the telephony network in order to provide the display of FIG. 4, in accordance with an embodiment of the invention. In step 601, the telephony network provides a call log of calls for an individual end user, such as call log 401-404 of FIG. 4. In step 602, the network provides a display of a call control rule applied to a call of the call log. As in columns 405-406, the call control rule includes a disposition 405 of the call as a result of the call control rule; and an identification 406 of one or more criteria that triggered application of the call control rule.

In another embodiment according to the invention, a technique similar to that of the embodiment of FIG. 4 may be used to allow a user of a telephony network to provide a display of call control rules in real time, as they are being applied. In this embodiment, similar techniques and components may be used, except that a real-time display of the treatment of an actual call is provided, without necessarily providing a call log. For example, when a monitoring system according to such an embodiment is operational, and a call is placed to a user's telephone number, a display shows the user in real-time how the call control rules are being applied to that call. For instance, the display may show the disposition and/or identification portion of the rule, and/or a familiar name for the call control rule. Such a real-time monitoring system may be useful, for example, for an element management system (as opposed to a typical end user of the network), to allow observation of real-time calls being treated according to a set of call control rules; and, optionally, building a call log as a result of those calls. Similarly, a call center could use such an embodiment to analyze the effect of load balancing rules, or to match incoming caller ID's against a database and differentially route the call. A real-time display may also be provided on customer equipment, which may be done in addition to providing the call logs described in embodiments above.

It should be appreciated that the methods described herein may be implemented in a variety of ways, including by using one or more processors to execute one or more sequences of instructions, which may be embodied on a computer-readable medium, or as a computer program product embodied on a propagated signal on a propagation medium. Such computer-readable media and computer program products may be embodied on any of a variety of different kinds of computer memories, such as floppy disks, conventional hard disks, CD-ROM's, Flash ROM's, non-volatile ROM's, RAM, Storage Media, or on any kind of signal containing instructions. In addition, techniques described herein may be used in a variety of different telephony networks, including Voice over Internet Protocol networks, wireless networks, Time Division Multiplexed networks, Advanced Intelligent networks, and combinations of such networks. Also, such techniques may be used in messaging services, such as voicemail services and Unified Messaging Services. For example, in a unified messaging service that includes call log and Find-Me-Follow-Me functionality, a customer could assess how changes in the Find-Me-Follow-Me, Key Contacts List, and notification (such as pager notification) option configurations would apply to calls in their call log. Methods described herein may be applied to various different kinds of calls, including both voice and facsimile calls.

FIG. 7 shows a Voice over Internet Protocol (VoIP) network, in which an embodiment according to the invention may be implemented. A Session Initiation Protocol (SIP) Server 711 functions as a softswitch, implementing call routing and call controls; and communicates with a Structured Query Language (SQL) Database 712 and an optional gateway 710 to the Public Switched Telephone Network (PSTN). The SQL database 712 stores current network addresses and phone numbers where a user can be reached; and also stores other per user information, such as the user's call control configurations. SQL database 712 communicates with user interface software 713, with which a user interacts (through any of the interfaces described herein) in order to implement the techniques described herein. In a VoIP network implementation of an embodiment according to the invention, a call identification engine, in communication with SQL database 712, may process the call log of actual calls of the user to identify applicability of the user's proposed call control rules. A customer rule change module, in communication with the user interface 713, may display the call dispositions that would occur, assuming implementation of the proposed call control rules. Similarly, a call log module and a call control module, in communication with the user interface 713, may provide a call log, and display the call control rules applied to the user's calls (respectively). It should be appreciated that the call identification engine, customer rule change module, call log module, and call control module may be integrated into existing components of the network of FIG. 7, as appropriate; and may be implemented in networks other than VoIP networks, as will be appreciated by those of skill in the art.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for implementing call controls in a telephony network, the method comprising:
processing a call log of actual calls for an individual end user of the telephony network to identify applicability, for each call of the call log, of each rule of a set of call control rules; and
providing a display of a call disposition that would occur for at least one call in the call log, assuming implementation of the set of call control rules.

2. A method according to claim 1, wherein the set of call control rules includes call control rule changes proposed by the end user but not yet implemented.

3. A method according to claim 1, wherein the display is on the end user's customer premises equipment.

4. A method according to claim 1, wherein the display is on a graphical user interface.

5. A method according to claim 1, wherein the call log comprises inbound calls to the end user.

6. A method according to claim 1, wherein the call log comprises outbound calls from the end user.

7. A method according to claim 1, wherein the telephony network comprises a Voice over Internet Protocol network, a wireless network, a Time Division Multiplexed network, an Advanced Intelligent network, or any combination thereof.

8. A method according to claim 1, wherein the method is applied to a call log in a voicemail service.

9. A method according to claim 1, wherein the method is applied to a call log in a Unified Messaging Service.

10. A method according to claim 1, further comprising:
providing a user interface element to receive a request from the end user to initiate the processing of the call log based on the set of call control rules.

11. A method according to claim 10, wherein the user interface element comprises a button.

12. A method according to claim 1, further comprising:
receiving, via end user interaction with a user interface element, a request to initiate the processing of the call log based on the set of call control rules.

13. A method according to claim 1, wherein each call control rule of the set of call control rules comprises an identification portion and a disposition portion.

14. A method according to claim 1, wherein the calls comprise facsimile calls.

15. A method according to claim 1, further comprising:
providing a display of a familiar name of a particular call control rule that caused the call disposition for the at least one call.

16. A method according to claim 1, wherein providing the display comprises displaying, in real time, the call control rule being applied to the call.

17. A method for implementing call controls in a telephony network, the method comprising:
providing a call log of calls for an individual end user of the telephony network; and
providing a display of a call control rule applied to a call of the call log, the display of the call control rule comprising: an identification of one or more criteria that triggered application of the call control rule, and a disposition of the call as a result of the call control rule.

18. A method according to claim 17, wherein the display is on the end user's customer premises equipment.

19. A method according to claim 17, wherein the display is on a graphical user interface.

20. A method according to claim 17, wherein the call log comprises inbound calls to the end user.

21. A method according to claim 17, wherein the call log comprises outbound calls from the end user.

22. A method according to claim 17, wherein the telephony network comprises a Voice over Internet Protocol network, a wireless network, a Time Division Multiplexed network, an Advanced Intelligent network, or any combination thereof.

23. A method according to claim 17, wherein the method is applied to a call log in a voicemail service.

24. A method according to claim 17, wherein the method is applied to a call log in a Unified Messaging Service.

25. A method according to claim 17, further comprising:
providing a user interface element to receive a request from the end user to display the identification of the one or more criteria that triggered application of the call control rule.

26. A method according to claim 25, wherein the user interface element comprises a button.

27. A method according to claim 17, further comprising:
receiving, via end user interaction with a user interface element, a request to display the identification of the one or more criteria that triggered application of the call control rule.

28. A method according to claim 17, wherein the calls comprise facsimile calls.

29. A method according to claim 17, further comprising:
providing a display of a familiar name of the call control rule.

30. A method according to claim 17, wherein providing the display comprises displaying, in real time, the call control rule being applied to the call.

31. A system for implementing call controls in a telephony network, the system comprising:
a call identification engine for processing a call log of actual calls for an individual end user of the telephony network to identify applicability, for each call of the call log, of each rule of a set of call control rules; and
a customer rule change module for providing a display of a call disposition that would occur for at least one call in the call log, assuming implementation of the set of call control rules.

32. A system according to claim 31, wherein the set of call control rules includes call control rule changes proposed by the end user but not yet implemented.

33. A system according to claim 31, wherein the display is on the end user's customer premises equipment.

34. A system according to claim 31, wherein the display is on a graphical user interface.

35. A system according to claim 31, further comprising:
a user interface element for receiving a request to initiate the processing of the call log based on the set of call control rules.

36. A system according to claim 35, wherein the user interface element comprises a button.

37. A system according to claim 36, wherein the user interface element comprises a button on the customer premises equipment.

38. A system for implementing call controls in a telephony network, the system comprising:
a call log module for providing a call log of calls for an individual end user of the telephony network; and
a call control module for providing a display of a call control rule applied to a call of the call log, the display of the call control rule comprising: an identification of one or more criteria that triggered application of the call control rule, and a disposition of the call as a result of the call control rule.

39. A system according to claim 38, wherein the display is on the end user's customer premises equipment.

40. A system according to claim 38, wherein the display is on a graphical user interface.

41. A system according to claim 38, further comprising:
a user interface element for receiving a request to display the call control rule applied to the call of the call log.

42. A system according to claim 41, wherein the user interface element comprises a button.

43. A system according to claim 42, wherein the user interface element comprises a button on the customer premises equipment.

44. A computer-readable medium having computer-executable instructions for:
processing a call log of actual calls for an individual end user of the telephony network to identify applicability, for each call of the call log, of each rule of a set of call control rules; and
providing a display of a call disposition that would occur for at least one call in the call log, assuming implementation of the set of call control rules.

45. A computer-readable medium having computer-executable instructions for:
providing a call log of calls for an individual end user of the telephony network; and
providing a display of a call control rule applied to a call of the call log, the display of the call control rule comprising: an identification of one or more criteria that triggered application of the call control rule, and a disposition of the call as a result of the call control rule.

46. A computer program propagated signal product embodied on a propagated signal on a propagation medium, such propagated signal carrying one or more sequences of computer-executable instructions for:
processing a call log of voice calls for an individual end user of the telephony network to identify applicability, for each call of the call log, of each rule of a set of call control rules; and
providing a display of a call disposition that would occur for at least one call in the call log, assuming implementation of the set of call control rules.

47. A computer program propagated signal product embodied on a propagated signal on a propagation medium, such propagated signal carrying one or more sequences of computer-executable instructions for:
providing a call log of calls for an individual end user of the telephony network; and
providing a display of a call control rule applied to a call of the call log, the display of the call control rule comprising: an identification of one or more criteria that triggered application of the call control rule, and a disposition of the call as a result of the call control rule.

48. A method for implementing call controls in a telephony network, the method comprising:
applying a call control rule to an actual call transmitted to the telephony network; and
providing a display, in real time, of the call control rule being applied to the actual call, the display of the call control rule comprising: an identification of one or more criteria that triggered application of the call control rule, and a disposition of the call as a result of the call control rule.

49. A method according to claim 48, further comprising:
providing a display of a familiar name of the call control rule.
